(19) United States
(12) Patent Application Publication
(10) Pub. No.: US 2020/0111045 A1
(43) Pub. Date: Apr. 9, 2020

(54) METHOD FOR ORGANIZING AND CARRYING OUT A TRAINING PROCESS

(71) Applicant: The Genesis Group LLC, Bostic, NC (US)

(72) Inventors: Deborah Cake Fortin, Bostic, NC (US); John Gregory Vincent, Bostic, NC (US)

(21) Appl. No.: 16/153,851

(22) Filed: Oct. 8, 2018

(51) Int. Cl. G06Q 10/06; G09B 19/16

(52) U.S. Cl. CPC G06Q 10/063114; G06Q 10/0637; G06Q 10/06398; G09B 19/162

(57) ABSTRACT

A method is presented for organizing and carrying out a training program, a seminar or a workshop having a plurality of participants to assist each participant in improving an efficiency and function of a business organization to which that participant belongs. The method exposes the participants to structures and regulations utilized for maintaining proper function of a deployed submarine having a plurality of crew members. Each crew member is subjected to a check-in procedure and required to assume ownership of a role. Each crew member must qualify to perform a function associated with the assumed role and each crew member has an assigned ombudsman. The training procedure then equates members of the business organization to which a participant belongs to those crew members. The invention has the advantage of improving performance elements dependent on factors which are of evident importance in a submarine environment but whose central relevance normally remains unnoticed in a normal business organization.

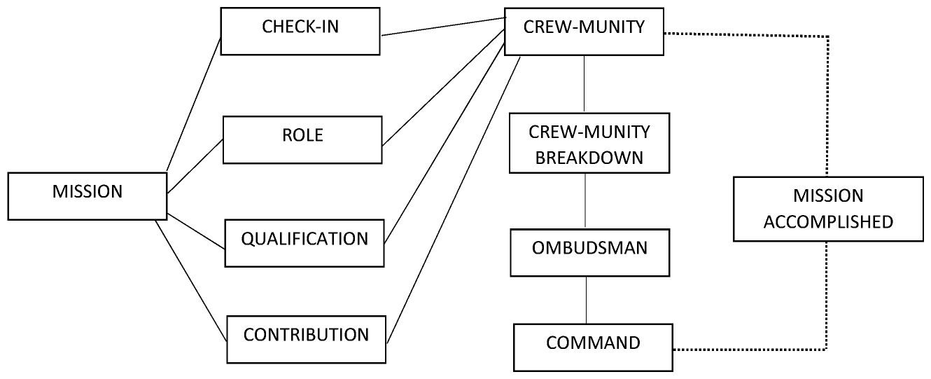

### BACKGROUND OF THE INVENTION

The instant invention concerns a method for organizing and carrying out a training program, a seminar or a workshop having a plurality of participants in order to assist each participant in improving an efficiency and function of a business organization to which that participant belongs. Such methods are known and supported by the Gallup organization (see gallup.com). In particular, the Gallup Q12 program utilizes an index having 12 central questions associated with an organization's employment engagement work. The Gallup Q12 program is based on a large amount of in-depth behavioral economic research involving a large number of employees. As a result of this research, Gallup has identified twelve core elements which the company refers to as the “Q12” which link powerfully to business outcomes. The twelve elements have emerged as a good means for predicting employee and workgroup performance. The employees are asked if they are aware of what aspects of their work are expected from them and if the materials or equipment necessary to perform that work have been provided to them. A survey procedure determines if the employees feel that they have the opportunity to do what they do best every day and if they receive recognition or praise for good work on a regular basis. The procedure is directed towards a subjective feeling on the part of the employee as to whether or not the supervisor or another person in the organization to which the individual belongs cares about that individual from a personal point of view and encourages his or her development. The employees are asked if their opinions seem to count and whether or not they feel that they are important within the context of the overall purpose of the organization. The attitude towards the quality of colleagues' performance is assessed and the individuals are asked if they have a good friend in the organization. The employees are asked if they have recently talked to someone in the company concerning their individual progress and development and as to whether or not an individual employee feels that he or she has an opportunity to learn and grow within the organization.

Accordingly, the Q12 system utilizes the subjective evaluation of the feelings and opinions of the employee as a monitor of the company. In consequence thereof, the Q12 procedure can lack objectivity and may overemphasize motivational issues rather than issues of employee performance per se. In view of the shortcomings of such prior art systems, it is the underlying purpose of the instant invention to develop a method for organizing and carrying out a training program which synthesizes particular elements which are likely to be the cause of poor performance or incompatibilities at the working site and to organize tools in order to prevent such negative influences from being amplified.

### SUMMARY OF THE INVENTION

This purpose is achieved in a method for organizing and carrying out a training program, a seminar or a workshop having a plurality of participants in order to assist each participant in improving an efficiency and function of a business organization to which that participant belongs, the method comprising the steps of:
a) exposing the participants to structures and regulations utilized for maintaining proper function of a deployed submarine having a plurality of crew members;

wherein the structures and regulations of step a) comprise the steps of:
b) subjecting each crew member to a check-in procedure;
c) requiring each crew member to assume ownership of a role;
d) qualifying, following steps b) and c), each crew member to perform a function associated with the role whose ownership was assumed in step c); and
e) providing the crew members with at least one ombudsman, whereby steps b) through d) are necessary and sufficient to establish a contribution of each crew member and an associated importance of that crew member;

the method further comprising the step of:
f) equating members of the business organization to which a participant belongs to the crew members of steps b) through e).

In accordance with the invention, it has been discovered that the problems occurring in a deployed submarine environment are no different than problems occurring in a normal working environment but are amplified to a great extent by the extremely cramped environment of the submarine and the fact that the deployed submarine is essentially an isolated system, which is substantially cut-off from the outside world and in which the crew members must manage to function under extremely difficult conditions. The submarine environment therefore provides a laboratory for the study of human behavior. In accordance with the invention, the Applicant has analyzed structures and procedures followed in a submarine environment (see the publication “DIVERSITY AND INCLUSION”, Deborah Cake Fortin and John Gregory Vincent, ADVANTAGE, Charleston, S.C., 2017. The entire disclosure of this publication is hereby incorporated by reference). The Applicant has then distilled the structures and procedures used on submarines into a group of procedures which are submarine specific. Submarine specific criteria were selected in order to isolate those elements which are essential to the proper performance of the deployed submarine, but which are not necessarily of obvious importance when applied to a potential business environment. By isolating these elements and directing the training program in accordance with the invention to those features, the instant invention focuses on aspects which are most likely to affect performance in a work place, but which would otherwise normally remain unnoticed in a normal working environment. The working hypothesis of the instant invention is that the importance of these elements remains hidden in a normal working environment and only becomes observable within the context of the high pressure and extremely confined environment of the submarine. By addressing these elements in the context of a business organization, the instant invention is therefore capable of addressing potential problems which would otherwise remain unnoticed in a business organization.

A number of terms are utilized in the claims. These terms are defined as follows.

### Mission:

This element refers to a clear understanding of the overall goals of the organization. All members of the organization must understand the mission and what their individual contribution to that mission is. A clear mission statement is more about what the organization is today, rather than a vision aimed at some point in the future. As such, the mission provides the framework for operating the organization on a day-to-day basis. Without clear boundaries and goals necessary for the mission to be accomplished, teams break down and the mission breaks down. All mid-level managers should share a common view and understanding of the mission. The mission of an organization should be reviewed and adjusted at least quarterly with significant input from mid-level managers. The goal with regard to this element is to assure that all members of the organization understand how the mission contributes to their daily responsibilities.

### Check-In:

The element “check-in” designates a system of introducing new members of an organization into that organization. When the check-in process is properly executed, crew members (business associates) have everything they need to do their jobs, including tools, contacts, and familiarity with the environment. They also understand their unique contribution to the success of an organization's mission and are welcomed according to their contributions. Building a thorough and positive check-in process serves to integrate a new member into the organization. The check-in process should be evaluated by surveying members who have gone through the check-in procedure. A successful check-in system results in the new member feeling welcome into the organization and having all key tools necessary for getting a good start in the organization. The new member must be introduced to individuals critical to the role which that member is likely to assume in the organization and should clearly explain the mission of the organization. The check-in procedure should be structured in such a fashion that changes to the procedure can be rapidly instituted. If the organization's mission changes, then the check-in procedure should be modified accordingly. The check-in procedure should be reviewed frequently, preferably three times more frequently than all other processes. The check-in process must be evaluated objectively and there should be one single individual in the organization who bears responsibility for the process. The check-in procedure in accordance with the invention differs from conventional introductory processes, since convention onboarding prepares the individual for activities associated with a particular job for which the new organization member has been hired. However, and in accordance with the invention, members of the business organization are encouraged and indeed expected to expand their activities in a discretionary fashion, which incorporates the particular individual talents of that member. This process is described more closely below in association with the definition of role assumption and ownership. Accordingly, and in anticipation of the broader activities to be assumed by the new individual in the course of engagement in the organization, the check-in procedure must be broad enough to provide at least some initial contact to areas of the organization with which a given individual would otherwise not generally be expected to interact. This requires a wider network of introductions to people and processes beyond the day to day job functions. The individual must therefore be exposed to members of the team, mission of the team, department and organization. This allows the individual to see how a potential role could fit into the mission of the organization. This broader check-in, with its expanded purpose, allows for innovation and creativity beyond the expectations of job function alone.

### Role Ownership:

The gist of this element is best understood by comparing it to that of a job or a job function. Job functions are the set of tasks assigned to someone through a job description and associated training. A role encompasses whatever is necessary to achieve the mission of the organization. Owning a role means that the individual puts in an extra effort over and above a mere checking-off of a list of daily job duties to evaluate and enact additional discretionary effort required to achieve the mission. Tasks assigned to each member of the organization should therefore be viewed by that individual as an opportunity to exercise additional discretionary steps which are consistent with the mission of the organization. The qualification procedure discussed below should be made contingent upon the successful ownership of a role in the organization. Six detailed examples of role ownership are given in the description of the preferred embodiment portion of this invention.

### Qualification:

This element constitutes an additional step of integrating a member of the organization into that organization. On a submarine, this element requires preparation for assuming the watch: a global responsibility for the operative safety of the submarine and accordingly for the entire crew. Once a crew member is checked-in, the qualification procedure is initiated. The new crew member is not fully accepted into the crew until he qualifies. This acceptance is signaled with the award of the Dolphins insignia medal which is then worn on the uniform. Accordingly, the time between check-in and qualification constitutes a probationary period which the new crew member must successfully negotiate in order to be completely accepted within the crew. In a business setting, this element can be enacted by initially providing new organization members with a non-permanent employment contract for a probationary period of time of several months. The new employee would then need to qualify for a non-probationary contract. The successful completion of the probationary period could be symbolized with a new contract, preferable accompanied by a salary increase. The qualification procedure should be a requirement for all new employees, regardless of their position in the organization. A modest insignia analogous to the submarine dolphin could also be awarded in a qualification ceremony. The qualification procedure can lead to an official certification following completion of training.

### Crew-Munity:

This element designates a healthy team where individual strengths blend into a coherent organization. Creating a crew-munity takes shared social experiences, social interactions, shared missions, and accountability to each other. To establish this element, the organization should have at least two or three activities annually which involve shared activities, and which include families. Specific individuals should be recognized during these events and the events should showcase the best things about the organization such as an anchor product, a specific talent, or something that the members of the organization can rally around. Developing this element requires sensitivity to the presence of conflicts between social groups in the organization. Accordingly, in contrast to the traditional approach to most teamwork, crew-munity is not a collection of job functions leading to a team of job functions, rather a collection of functions which have been expanded into roles through the individual and discretionary assumption of additional activities developed by the individuals in the organization and accordingly built on the strengths of the individuals who contribute to the organization. The check-in procedure is central to the development of crew-munity.

### Ombudsman:

An official liaison to the command, the ombudsman takes the pulse of the crew-munity. In the business world, ombudsmen have direct access to the most senior leaders of the organization and have the authority to drive change. An ombudsman is not a figurehead, but an integral part of the team with high-ranking status. Conventional organizational structures give employees two channels for advocacy, Human Resources and a direct supervisor. However, in this traditional model, loyalty from both individuals is to the company and not to the crew-munity. The unique features of the ombudsman include, direct access to the highest leaders, without being filtered on the way up and loyalty to the crew-munity. Ombudsmen must be unconditionally trustworthy and possess sufficient character to assure that individuals come to them to have their problems addressed. Since the ombudsman has access to leaders, he or she has strength in advocacy and as a consequence, problems are solved rapidly and at an earlier stage.

### Contribution:

This element reflects the goal of asserting the importance of each individual to the organization. This is the process of identifying team members' unique contributions, providing the training to make sure they are successful, and then holding them accountable for their results. Having high levels of accountability during training is key (keeping in mind that the training never ends). This element can be encouraged by assuring that critical meetings are not always attended by the same people. Unlike the conventional approach to inclusion that assumes everyone has intrinsic value based on their job function, this element seeks out talent in each individual that can be developed.

The dependent claims of the instant invention address a plurality of improvements to the core elements of the inventive method. The advantages of these improvements are discussed below.

In accordance with a preferred embodiment of the invention, the method further comprises the step of defining a mission for the business organization. This step has the advantage of providing focus for the remaining steps and an overall background goal for the organization which the individual can utilize as a guide to monitor his or her performance.

In a further improvement of this embodiment, the mission is defined in view of customer satisfaction. Customer satisfaction is a reliable means of evaluating the efficiency and success of a business organization and is directly associated with the economic success of the organization.

In a further improvement of this embodiment, the contribution of each individual to the organization is evaluated in view of the mission. This step has the advantage of focusing the efforts of individuals within the organization on the overall purpose of the organization and therefore extends evaluation of the contribution of the individual beyond the detailed job normally performed by that individual.

In a further embodiment, the roll accepted by an individual is developed in view of the mission. This step has the advantage of providing the frame work for an individual who is in the process of carrying out a particular task or addressing a particular problem within the organization by evaluating the effect of steps taken or decisions made on the overall health and direction of the organization per se. By asking this question and by taking decisions which are supportive of the overall mission of the organization, each individual in the organization assumes a role whose aspects are based on an improvement of the overall organization per se and not merely addressed to the particular task in hand.

In a further preferred embodiment, a mentor is assigned to each member of the business organization. The assignment of a mentor is particularly important for the development of an individual, since each member of the organization should feel that at least one person cares about their personal progress. A mentor is then typically a person of experience in the organization and a person of trust to which the individual can go for assistance in personal or business matters.

In a further preferred embodiment, each member of the business organization is trained to exercise their assumed role. This step has the advantage of utilizing the discretional decisions of an individual expanding their task in view of the overall mission of the organization to allow the individuals' unique specialties and talents to be developed. Since each individual will take discretional decisions which differ from decisions which would have been taken by another individual facing the same task, it is precisely those differences which define the particular talents that a given individual has and the development of those talents leads to an overall improvement not only in the personal development of that individual but also in the contribution of that individual to the organization. Training is therefore strengths focused, not job focused and encourages innovation and role ownership concepts.

In a preferred embodiment of the invention, additional leadership responsibilities are assigned to members of the business organization whose roles emphasize the mission. This step has the advantage of advancing people within the organization who have successfully identified the difference between performing a job and expanding their job performance into a role which includes additional discretionary measures which are unique to that individual but nevertheless mission-directed. By putting such individuals in leadership positions, the importance of the role assumption step within the organization is emphasized and the ability of the organization to encourage role development is improved. Leadership is therefore strength and role focused and not only dependent on job function. Such leadership develops strengths and ties those strengths to the mission and understands the importance of check in to the success of the crew-munity.

In a further preferred embodiment of the invention, the organization is evaluated with regard to crew-munity spirit. This criterion has the advantage of evaluating the success of the organization not merely on a monetary level or based on customer satisfaction alone. This criterion turns the evaluation inward to an analysis of the degree to which the members of the organization are pleased to be a part of that organization. This emphasize alone encourages and emphasizes the importance of cooperation among the members of the organization.

In a further preferred embodiment of the invention, norms are established for the organization. Norms, or fixed rules of behavior, include an expectation that individuals develop individual roles which focus on the mission of the organization as well as the support of every individual in the crew-munity. Such norms allow individuals to eliminate problems which could distract from the overall decision-making progress within the organization. Norms also serve to assist each organization member in identifying with the organization. Norms expect full ownership of roles, focus on the mission, and on the advocacy of every member of the crew-munity.

In a further preferred embodiment of the invention, crew-munity development is supported on the basis of the role assumed by an individual. This step supports the efforts of individuals to expand their job tasks through discretionary additional steps directed towards improvement of the mission of the overall organization. Accordingly, by honoring the impact of discretionary additional steps taken by the individual assuming the role on the overall teamwork of the organization, the organization acknowledges the importance of crew-munity and also permits the special talents of each individual to be developed and to be supported by the members of the organization.

A schematic block diagram of the principal elements of the invention is given below. This schematic diagram and embodiments discussed subsequent thereto are not to be considered as constituting an exhaustive enumeration of all, important inventive elements, rather have exemplary character for illustration of the invention.

### BRIEF DESCRIPTION OF THE DRAWING

The sole drawing is a block diagram of the key steps involved in accordance with the instant invention.

### DESCRIPTION OF THE PREFERRED EMBODIMENT

The drawing illustrates connecting structures among the mission, the check-in procedure, role assumption, the qualification procedure and the contribution of an individual to the organization. Each of these method steps which are taught within the context of an inventive training program are key features of the development of the instant invention within the context of an improved organization function. The connections among these elements indicate their interdependence and the effect of one element on the other. The first element to be established is the mission. This element must be in place at the time in which check-in occurs. The check-in procedure conveys a clear understanding of the possible role an individual may assume within the context of the mission and therefore defines the contribution which an individual can make to that mission. Accordingly, the qualification procedure is also defined by the mission. All these elements lead to crew-munity which assures that the mission is accomplished. If a rare breakdown in crew-munity occurs and pursuit of the mission is interrupted, the ombudsman is activated and works with the command (upper levels of management) to assure that mission pursuit is resumed.

The following examples of the invention illustrate theoretical situations which could exist in an organization and which are addressed by the inventive procedure. Particular emphasize is given to the difference between role assumption and job performance in order to emphasize the interconnections among the elements with regard to the mission of the organization. Examples 1, 2 and 3 are taken from a submarine in order to illustrate the applicability of the invention to the business environment, departing from the specialized confines of a submarine. Examples 4 through 6 are explicitly directed to business organizations per se and reflect mapping of the features of examples 1 through 3 into a business setting.

### Example 1

A chart petty officer in the navigation division is tasked with ensuring that the submarine has the required charts for an upcoming deployment to the northern Atlantic Ocean. Utilizing a role mindset, he first looks up the standard chart package for this area of deployment. If he were just doing his job, he would conduct inventory and order any charts that were not already on board or that were on board but not in the proper quantity. In a role mindset, the chart petty officer sits down with the senior enlisted officer in the navigation department and asks if there are any charts of which he is aware that would be helpful. From this meeting, he broadens his grasp of the task at hand and decides to add 6 charts which were not “required” and to also add to the carried quantity of 10 other charts. He then approaches the submarine squadron and talks with the lead navigator. He inquires as to which boats in the squadron had been in this area during the past 24 months, in order to determine what new information had been discovered in the area. Since the lead navigator had told him he had been to this area several times, he asked the lead navigator if he knew of any charts outside the required charts which were helpful. He had 4 (already mentioned by his senior enlisted) but also recommended a coastal guide book for a certain area that he said had been invaluable to him. The chart petty officer then set up 3 meetings over the next 3 months with lead navigators on three other boats. The final result of this process led the chart petty officer to order 46 additional charts and 4 publications, none of which were required. The boat deployed for 4 months during this deployment and was redirected to an area outside of the “standard area”. The boat would not have had chart coverage, but since one of the lead navigators he spoke to had told him this was an area boats were sometimes redirected to, he had chart coverage. An improved mission was the result. This result occurred because the chart petty officer went far beyond his “job requirements” to assume a role, in this case the safe navigation of the submarine so it would be ready to fight, regardless of where it was directed.

### Example 2

A chief machinist (responsible for literally all the hydraulics, low and high-pressure air and literally every non-nuclear related valve, pipe and piece of machinery on the submarine) had a rare quiet period: the submarine was in port and his crew was not required to work its typical 18 hour, 7 days a week schedule. His job was to keep his 6 men busy doing preventive maintenance, cleaning, etc. Since there are always things that need to be done, this job was one which was never completed. This chief brought a role mindset to his work. Knowing that the principle responsibility of his division was having everything in top shape to go to sea and then, once at sea, doing everything they could to maintain and repair all the systems, such that the submarine could complete the mission, there was often no time for rest and no time for much sleep once they were at sea. So, he made a highly unconventional decision to essentially shut down for 5 days, keeping just 2 sailors onboard for watch and routine maintenance, and rotating the others through one or two full days off to spend with family or friends as they saw fit. The result was that he went to sea with all systems fully operational and with a division of men both rested and deeply appreciative of what he had done. They were capable of more rapid response to mechanical issues and could produce better results for the duration of the 45 days they were at sea. The two vacation days therefore produced 45 days of higher productivity. For this Chief to make these types of far reaching strategic decisions he needed to recognize the overall effect of his decisions on the entire mission and assume the role necessary to optimize mission results. Only a role ownership view can do this. In this case it was to focus on the mission, not just the task at hand. Since he owned his role he went beyond just doing his job to looking strategically at his staff and thinking of the future impact of current decisions.

### Example 3

A Senior Chief Quartermaster has a paygrade of E-8. Enlisted men paygrades run from E-1 to E-9 so he is a senior person. Most 110-person submarines have no more than 3 senior chiefs. His job is to assure that the submarine is safely navigated while at sea. In port, a division of 5 is updating charts, making corrections, keeping their work spaces cleaned and stowed, and conducting training for both their division and for those that support their division. This senior chief had a role mindset. The mess specialist division (the cooks) were short three people but still had to load 60 days of food for an upcoming underway. Thousands of cans, bags etc. then had to be stowed, literally all over the submarine, while ensuring they would not rattle, roll, make noise, or in any way cause a fire or trip hazard. This is no small feat in a submarine. Since the Senior Chief Quartermaster was thinking role, in this case supporting the most important mission and getting the entire crew ready to sail, he did something rather unusual. He sent all but one of his sailors to work with the mess specialists for 6 days. During this time his sailors helped store every can, every bag and every bit of food for the entire crew. They worked in 12-hour shifts. Since he still had responsibilities to prepare the navigation division for sea, he and the one remaining sailor also assumed 12-hours-on, 12-hours-off, shift work to do all the preparations, all the cleaning and all the maintenance. Accordingly, the 3rd most senior enlisted person on this submarine could be seen at 10 PM on his hands and knees scrubbing the periscope stand and the deck surrounding the dive station. Sending those sailors to another division was not his job. Scrubbing decks and correcting charts was also not his job. However, this Senior Chief Quartermaster embraced a role to take decisions as viewed through the perspective of a larger, more strategic lens. Role ownership reflected his realization that not the individual, rather the overall crew is of paramount importance. This approach led to better results both for parts of the organization as well as for the entire organization.

### Example 4

A training consultant is asked to create a leadership training program for a manufacturing client. The client manufactures desks and chairs used in primary schools throughout the country. The training company has numerous leadership programs that have been built over the years for other clients. The consultant is not familiar with this industry but is very familiar with all of the leadership programs. Operating in the mindset of being in a role, she starts by spending two days learning about this type of manufacturing. It is during this time she discovers this business is very cyclical: they have two peak manufacturing times during the year and, outside of those times, manufacture at less than full capacity. This requires them to fill their staff with temporary employees to handle the peaks. The consultant took what she learned, requested and conducted a follow up 2-hour meeting with the client to learn if this industry cycle applied to them, which it did. She then was able to ask follow-up questions to find out the specific leadership and management issues this caused for them. In their case, it was quality issues related to the temporary staffing additions, as well as teamwork issues, between the temporary and permanent staff. Armed with this information, the training consultant reviewed all available material and then had three two-hour meetings with the company's design team, and created a tailored solution aimed at their two biggest challenges. Additionally, in her follow up meeting two weeks later with the client, she recommended a review of their manufacturing processes. Her company did not do this type of work, but she could recommend a suitable company with which her company had worked in the past. The approach taken by this training consultant went well beyond her job (function) of delivering a correct training program to the client. This job could have been done by making small adjustments to standard programs, without any research or any meaningful dialog, and delivering it in a timely manner to the client. This training consultant evolved from the understanding that she needed to deliver adequate training, to a mindset of role ownership. Through role ownership she grew to understand that this training needed to deliver change, far beyond the function of her job. The result of role ownership was a series of workshops to address the key issues and arm the staff with practical tools to overcome their most substantial challenges.

### Example 5

A call center representative trained to answer questions from customers who call about product discounts on consumer package goods, receives a call from a customer who has received an electronic coupon on her Facebook page. The representative has never heard of electronic coupons, has never been trained in this regard, and also suspects that this could be a customer trying to secure a discount where none is warranted. She questions the customer to learn more about the coupon, even though she has been trained on 100 non-electronic coupons from 10 different consumer package good manufacturers. The discount on this electronic coupon is 50% of the cost of whatever is purchased. The representative asks many questions such as 1) who manufactured this product 2) how did it appear on your Facebook page, and 3) could you send me a screen shot of this coupon? The customer complies and tells the representative that this coupon was the most exciting thing to happen to her lately, because it allowed her to buy unlimited, ruled notebooks, which she could then provide to underprivileged children starting school in numerous schools in the area. After looking into the coupon, the representative was convinced that the coupon could be legitimate and since the customer was clearly sincere, the representative contacted the Internet marketing department for additional information. The representative was discouraged from doing this by superiors, since training on the 100 coupons and 10 clients was viewed as being sufficient for most interactions. The internet marketing department did not recognize the coupon but allowed the customer and the retailer to benefit from the coupon after the representative made her extensive case in their favor. In this situation, the representative went beyond the transactional job function of 100 coupons and 10 clients to putting the experience of the customer first and interacting with the internet marketing department to achieve a broader goal, which was beyond the strict requirements of her job. This occurred because she embraced a role ownership view by examining the task within the context of the overall mission of the organization to which she belonged and by exhibiting a willingness to execute on actions necessary to achieve the best contribution to the customer requirements, within the context of that organization mission.

### Example 6

An executive of a tax credit company was asked to lead a project that would build capability for a new tax credit, which just passed legislation. This executive familiarized herself with the company's goal with regard to this credit, namely to “build a capability to capture this new tax credit information, capture as much revenue as possible, maximize it, and satisfy clients by assuring that at tax time, they had the information they needed to take a tax credit.” She accepted the challenge and began to formulate a plan. Although she knew this was not her job function, and that nowhere in her job description was she required to engage in two fulltime job functions, she realized that this new assignment was a clear opportunity to assume a role which encompassed the functions of maximizing revenue, being responsive to the dynamic needs of the industry and building an as yet untapped capability to qualify and capture new tax credit candidates. The next step was to contact other departments, build a project plan and identify the technology capable of delivering the plan. She set up a meeting with 20 individuals from 20 departments, laying out the goal. Many of those individuals were reluctant to cooperate, saying building this technology and executing the project plan was not their job. Because she was sure that her assumed role was critical, she persisted in her efforts to convince each of the individuals to participate by arguing that successful execution of the goal would allow clients to receive the tax credits they needed and had asked for, without each one of them having to make a separate, atypical request. A project plan was built having technology including a voice response IVR which was needed to capture the qualifying information representing a tax credit from each new customer, a report from the Data Reporting division that gathered all of this IVR data in the format the Federal Government needed for tax credits, a script from the client service department to discuss what was being built with each client and a clear directive to the sales department to sell the service concept to clients. Every single person contributing to the project plan went beyond their individual jobs to assume role ownership. They went beyond interaction with clients to improvement in client satisfaction, the ultimate goal for anyone dealing with clients. This happened because all people involved embraced a collaborative approach, putting mission (the client experience) ahead of their individual agendas.

We claim:

1. A method for organizing and carrying out a training program, a seminar or a workshop having a plurality of participants in order to assist each participant in improving an efficiency and function of a business organization to which that participant belongs, the method comprising the steps of:
a) exposing the participants to structures and regulations utilized for maintaining proper function of a deployed submarine having a plurality of crew members;
wherein the structures and regulations of step a) comprise the steps of:
b) subjecting each crew member to a check-in procedure;
c) requiring each crew member to assume ownership of a role;
d) qualifying, following steps b) and c), each crew member to perform a function associated with the role whose ownership was assumed in step c); and
e) providing the crew members with at least one ombudsman, whereby steps b) through d) are necessary and sufficient to establish a contribution of each crew member and an associated importance of that crew member;
the method further comprising the step of:
f) equating members of the business organization to which a participant belongs to the crew members of steps b) through e).

2. The method of claim 1, further comprising defining a mission for the business organization.

3. The method of claim 2, wherein the mission is defined in view of customer satisfaction.

4. The method of claim 2, wherein the contribution of step e) is evaluated in view of the mission.

5. The method of claim 2, wherein step c) comprises the steps of defining the role in view of the mission.

6. The method of claim 1, further comprising the step of assigning a mentor to each member of the business organization.

7. The method of claim 1, further comprising training each member of the business organization to exercise the role assumed in step c).

8. The method of claim 5, further comprising assigning additional leadership responsibilities to members of the business organization whose roles emphasize the mission.

9. The method of claim 1, further comprising evaluating the organization with regard to a crew-munity spirit.

10. The method of claim 1, further comprising establishing norms for the organization.

11. The method of claim 1, further comprising supporting career development based on the role assumed in step c).
